(19) United States
(12) Patent Application Publication
(10) Pub. No.: US 2012/0246111 A1
(43) Pub. Date: Sep. 27, 2012

(54) Enhanced Rapid Business Intelligence Development and Deployment

(76) Inventor: Sona Raja, Derry, NH (US)

(21) Appl. No.: 13/348,345

(22) Filed: Jan. 11, 2012

Related U.S. Application Data
(60) Provisional application No. 61/432,516, filed on Jan. 13, 2011.

(51) Int. Cl. G06F 7/00; G06F 17/30

(52) U.S. Cl. 707/603; 707/E17.005

(57) ABSTRACT

This invention illustrates a computer system to rapidly develop and deploy a business intelligence system for enterprises of various sizes with minimal human effort. The said computer system, based on certain information gathered from existing artifacts and certain new artifacts, intelligently generates and deploys the business intelligence reporting, analytics with minimal human effort.

### CROSS-REFERENCE TO RELATED APPLICATION

This application claims the benefit of U.S. Provisional Application No. 61/432,516, Confirmation Number 4149, filed 13 Jan. 2011, Title: Emhanced Rapid Business Intelligence Development and Deployment.

### BACKGROUND OF THE INVENTION

This application claims the benefit of U.S. Provisional Application No. 61/432,516, Confirmation Number 4149, filed 13 Jan. 2011, Title: Emhanced Rapid Business Intelligence Development and Deployment.

This invention relates to innovation in developing and deploying business intelligence information systems as compared to the current practice, in specific, to improve the quality of and time consumed in development and deployment of such systems.

At the present time, the design process (data design, business intelligence design etc.,) is separated from analytics development and deployment. This means that the information captured during the data design and business intelligence design process is not used effectively to reduce the lifecycle of business intelligence systems development and deployment.

Given this background the inventor hereby proposes the said computer system where the information captured during the data design and business intelligence design process is used to develop and deploy business intelligence reporting, analytics with minimal human effort;

### BRIEF SUMMARY OF THE INVENTION

This application claims the benefit of U.S. Provisional Application No. 61/432,516, Confirmation Number 4149, filed 13 Jan. 2011, Title: Enhanced Rapid Business Intelligence Development and Deployment.

According to this invention, information captured during the data design and business intelligence design and development process is used to develop and deploy business intelligence reporting, analytics with minimal human effort.

The said computer system, analyzes the business relationships, measures, attributes, relationships between dimensional attributes, facts measures, that are typical of the business intelligence systems, established in the Data Design and/or business intelligence design using the said existing data design artifacts, underlying data and uses these established relationships to create and store said algorithms. The data and/or business relationships are relational, cubes, fact-dimensions, bridges, one-many, many-one, many-many, hierarchical, level based etc., to name a few and these are apparent to the people in this trade. The said Computer System apart from developing these analytics will also deploy the same in a generic way.

In addition to the said existing data design artifacts, the said Computer System will also use create new “data design” artifacts to gather additional information from the business intelligence designer to store them as said algorithms

The said computer system uses the said algorithms to generate the said analytics.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing, pictorially, how the said Rapid Business Intelligence Development System will be implemented. As depicted in the diagram, said existing design artifacts (Data Design, BI Design artifacts serves as an example), underlying data and said new design artifacts (said Configurator) serves as inputs. RBID's Relationship Analyzer and Attributes, Facts, Derived Facts Analyzer finds the various relational, business, dimensional, hierarchical relationships and relationships between dimensional attributes, fact measures, among dimensional attributes, among fact measures; wherein, configuration processor processes the additional information gathered; all the above are converted into said algorithms and serves as the input to Analytics Generator that uses the same and generates the Analytics System. RBID Deployer deploys the generated the Analytics System in various forms such as Dashboards.

FIG. 2 serves as an illustration of how the said computer system can use the said design artifacts and generate said analytics. It shows one of popular versions of data model diagrams practiced widely in the industry called ER Diagram. This ER Diagram specifically describes a data model for a fictitious sales organization. From this Data Model the said computer system (RBID) can analyze the various dimensional (Sales Fact to Customer Dimension, Store Dimension, Product Dimension etc) and hierarchical relationships, and relationships between dimensional attributes, fact measures, among dimensional attributes, among fact measures and convert them into said algorithms and utilize the same to generate the business intelligence analytics.

### DETAILED DESCRIPTION OF THE INVENTION

In the interest of clarity, not all features and variations of an actual implementation are described in this specification. It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Also, as is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. Thus, while the preferred embodiment of the invention has been illustrated and described, it will be appreciated that various changes can be made therein without departing from the spirit and scope of the invention and for this reason protection is sought to encompass all these changes.

Reference will now be made in detail to the present invention in detail clearly illustrated using the accompanying drawings.

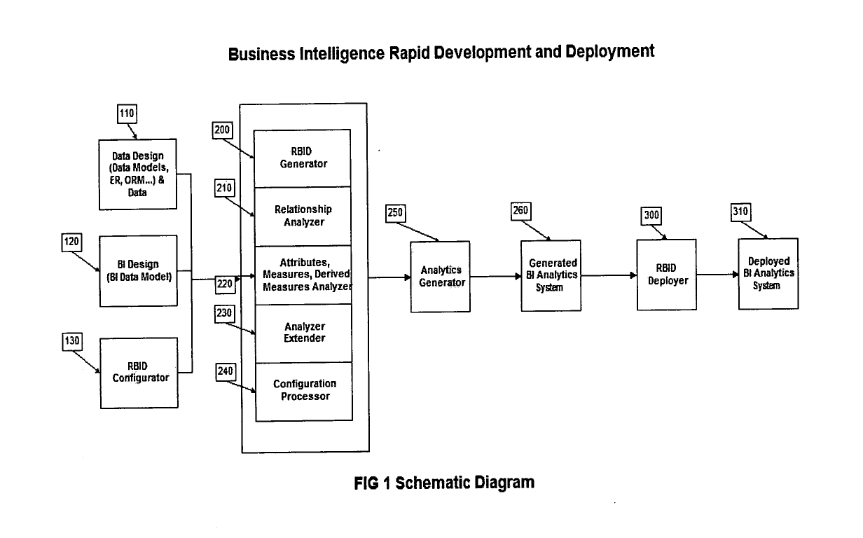

FIG. 1 shows how the said Rapid Business Intelligence Development System will be implemented. As depicted in the schematic diagram, the Data Design and Data Sub-System 110 and BI Design Sub-System 120 serve as the input along with the Configurator Sub-System 130. RBID's Relationship Analyzer Sub-System 210 analyzes said parameters such as, but not limited to, dimensional, hierarchical, star, snowflake, master-child, one-many, many-many relationships and converts them into said algorithms; wherein Attributes, Measures, Derived Measures Analyzer Sub-System 220 finds and documents the attributes, facts, derived facts, rollup facts, trend facts, relationships between dimensional attributes, fact measures, among dimensional attributes, among fact measures and converts them into said algorithms; Also, this Sub-System groups dimensional attributes and fact measures by analyzing the underlying data and applying various scientific and mathematical formulae such as Correlation Coefficient, Bands; Correlation Coefficient is applied between the available dimensional attributes, fact measures to find those with high degree of positive or negative coefficients and group them together; Band is to find the dimensional attributes, fact measures that have values that are closer to each other, create bands of attributes or measures and group those together; all of the above processes are converted into algorithms. Configuration Processor Sub-System 240 processes the adjustments Users made to the output of the Sub-Systems such as 210, 220 and also processes the additional information gathered such as type of analysis (Time Series, Trend, Basic; Time Interval), Analysis Format, preferred attributes & facts for reporting, preferred attributes to filter, filtering types etc. into said algorithms; Analyzer Extender Sub-System 230 is a container that will serve to add new analyzers as the business intelligence technology changes and adds new features such as new standards to store said data design, new business relationships, new business objects that complements or supplements existing business intelligence objects; Sub-Systems 210, 220, 230, 240 serve as input to Analytics Generator Sub-System 250 that uses the said algorithms to generate the Analytics System. RBID Deployer Sub-System 300 deploys the generated the Analytics System in various forms such as Business Intelligence Dashboards. In essence, these Sub-Systems are designed to process business relationships, data relationships, business rules based on prevalent and new practices in the business intelligence field and is not restricted to certain relationships and logics alone specified in this invention.

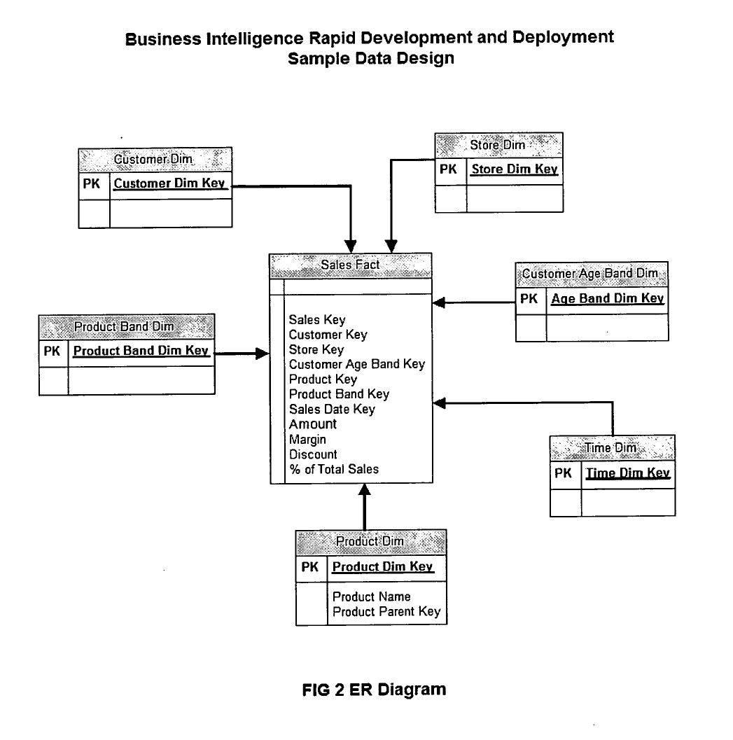

FIG. 2 serves as an illustration of how the said computer system can use the said design artifacts and generate said analytics. FIG. 2 shows one of popular versions of data model diagrams practiced widely in the industry for modeling relational database design and dimensional database design called ER Diagram and serves only as an example, explains only few of the concepts and does not represent the complete scope and spirit of this invention. This ER Diagram describes a data model for a fictitious sales organization to explain this invention in detail. From this Data Model, RBID system can analyze the various dimensional (Sales Fact to Customer Dim, Store Dim, Product Dim etc), hierarchical relationships (present in Product Dim), star, snowflake, mater-child and utilize this information to generate the business intelligence analytics. For example, RBID's Relationship Analyzer Sub-System can infer that the business intelligence designer has a Sales Fact and interested in reporting sales by following dimensions: Customer, Product, Store, Customer Age Band, Time, and Product Band etc. Also, this Sub-System will also document the hierarchical relationship present in the Product Dimension (Product Dim Entity). All this knowledge will be created as said algorithms. RBID's Attributes, Facts, Derived Facts Analyzer Sub-System can infer the dimensional attributes and facts the said designer is interested in. This Sub-System will also analyze the underlying data for this data model by applying various scientific and mathematical formulae such as Correlation Coefficient, Bands between the available dimensional attributes, fact measures to find those with high degree of positive or negative coefficients, Bands etc., The same sub-system will also document the derived measure such as ‘% of Total Sales’ for special analytics. All this knowledge will be created as said algorithms. RBID's Configuration Processor Sub-System will gather related details, such as, needed fact-dimensional combinations, needed hierarchical analysis, needed fact and dimensional attributes, type of analysis, analysis formats etc., to produce precise analytics. All this knowledge will be created as said algorithms. Using the said algorithms generated as illustrated above, RBID's Analytics Generator Sub-System is well equipped to generate precise analytics in the formats specific to the desired business intelligence tools in the market. Examples of such generated analytics are, in this specific example, Sales Analytics by Customer, Sales Analytics by Customer & Product, Sales Analytics by Store, Customer & Product, Sales Analytics by Product Hierarchy etc., Also, as is understood by a person skilled in the art, RBID System can use various other inputs such as business models, business diagrams, presentation models, presentation layers that reveals the said input parameters to implement this invention; inputs such as that are customer specific and inputs that are industry specific, also can be used to implement this invention.

All the several objects of this invention have been described in terms of particular embodiments. Obviously, modifications and alterations will be apparent to those skilled in the art in view of this disclosure, including, but not limited to various ways and means that can be designed to achieve the said RBID System, Hardware & Software Modules used to implement this invention, Software/Hardware Technology used to implement this invention, Placement of those Modules, Modes of Communication between various sub-modules etc. It is therefore intended that all such equipments, variations, and modifications fall within the spirit and scope of the invention as claimed.

What is claimed is:

1) A computer system to gather the needed information using multitude of existing design artifacts that is available in any business intelligence systems and underlying data in addition to using new design artifacts and convert the said needed information into algorithms to develop and deploy the business intelligence reporting and analytics with minimal human effort;
and the said “business intelligence systems” is meant to include, but not limited to, OLAP, ROLAP, MOLAP, transaction business intelligence systems, predictive business intelligence systems, any other business intelligence systems and henceforth referred to as “business intelligence” or “BI”;
and the said multitude of “existing design artifacts” is meant to include, but not limited to, design documents, data models, business models, business intelligence models, business intelligence design layers such as presentation layers, business layers, business models or any such artifacts that is created as part of and/or outside the business intelligence systems or as integral part of the business intelligence systems and such data design artifacts may be designed and developed using a variety of industry standard methodologies such as ER Diagrams, Standardized ER Diagrams in standardized formats such as ERX, ORM, Bachman Diagrams, UMLs, UDMLs, XMLs, XDMF, and/or proprietary methodologies;
and the said multitude of “existing design artifacts” is also meant to include, but not limited to vertical industry specific data models & methodologies (Industry Data Models) such as SDM, ARTS;
and the said “reporting and analytics” is meant to include, but not limited to, information generated by the business intelligence systems and delivered or displayed in an understandable format such as static reports, interactive reports, representative models, drill down/drill across/drill through reports and henceforth referred to as “analytics”;

2) System of claim 1, wherein the said computer system collects the said needed information using, but not limited to, business relationships, dimensional relationships, cubes, facts, bridges, measures, derived measures henceforth referred to as parameters, from the said existing design artifacts and converts them into said algorithms;

3) System of claim 1, wherein the said computer system collects additional needed information from the said “new design artifacts” and converts them into said algorithms; the said new design artifacts serves the purpose of answering additional design questions to supplement the needed information to develop and deploy the said analytics;
henceforth the “new design artifacts” is also referred to as “Configurator”;

4) System of claim 1, wherein the said computer system, utilizes the Systems claimed in 2 and 3 to develop and deploy the business intelligence reporting, analytics with minimal human effort;

5) System of claim 2, wherein the said “algorithms” is meant to include, but not limited to, business relationships, data relationships, relational & dimensional relationships, star, snowflake relationships, one-one, one-many, master-child relationships, joins, cubes, facts, measures, derived measures, correlation between dimensional attributes, correlation between fact measures, correlation between dimensional attributes and fact measures, various types of facts—such as rollups, trends, numeric, non-numeric etc., and available in or converted into computer readable form and optionally in one or more of the industry standard format such as XML, UML, UDML.

5) System of claim 1, wherein the said computer system is henceforth also referred to as “Rapid Business Intelligence Development System” or “RBID”

6) Various modifications and alterations will be apparent to those skilled in the art in view of this disclosure; few examples are: numerous design documents related to the business intelligence systems, sequence in which the algorithms can be applied, new additions in design artifacts, business intelligence etc.; it is therefore intended that all such systems, variations, and modifications fall within the spirit and scope of the invention as claimed.
